(19) United States
(12) Patent Application Publication
(10) Pub. No.: US 2026/0031717 A1
(43) Pub. Date: Jan. 29, 2026

(54) MULTI-PHASE POWER CONVERTER CIRCUIT LAYOUT TO MINIMIZE DRIVE LOOP AND POWER LOOP INDUCTANCES

(71) Applicant: MAGNA POWERTRAIN GMBH & CO KG, Lannach (AT)

(72) Inventors: Xiang YU, Kingston (CA); Mojtaba FOROUZESH, Kingston (CA); Yang CHEN, Kingston (CA); Bo SHENG, Kingston (CA); Samuel Dylan WEBB, Unionville (CA); Yan-fei LIU, Kingston (CA); Philip KORTA, Troy, MI (US); Oliver OBERLEITNER, Wels (AT); Michael NEUDORFHOFER, Hofkirchen im Traunkreis (AT); Lakshmi Varaha IYER, Windsor (CA); Martin WINTER, Dietach (AT)

(21) Appl. No.: 18/996,848

(22) PCT Filed: Jul. 13, 2023
(86) PCT No.: PCT/EP2023/069576

§ 371 Date: Jan. 17, 2025

Related U.S. Application Data
(60) Provisional application No. 63/390,020, filed on Jul. 18, 2022.

(51) Int. Cl. H02M 3/00; H02M 3/28; H02M 3/335

(52) U.S. Cl. CPC H02M 3/003; H02M 3/285; H02M 3/33576

(57) ABSTRACT

A multi-phase power converter includes a printed circuit board having a plurality of conductive layers in a spaced apart and parallel relationship. The plurality of conductive layers includes a plurality of power planes in an interleaved configuration with alternating positive and negative voltages and configured to conduct a relatively high current for supplying to a load. The multi-phase power converter also includes a plurality of switching transistors disposed on an upper surface of the printed circuit board and configured to selectively conduct the relatively high current. The conductive layers include at least one signal plane disposed between the plurality of power planes and a surface of the printed circuit board, the at least one signal plane transmitting signals for controlling operation of the plurality of switching transistors. A power converter phase includes a high-side transistor, a low-side transistor, and a driver circuit disposed adjacent to the transistors.

### FIELD

The present disclosure relates generally to physical circuit layouts for power converters, such as multi-phase DC-DC power converters.

### BACKGROUND

Power converters may be used in a variety of different applications e.g., server power supply, LV dc-dc converter in electric vehicles (EVs). In many such applications, the power converters may have output current as high as several hundred to several thousand amps, which can become a bottleneck to improving converter efficiency. In such a case, multi-phase technology is frequently employed to decrease conduction loss and to increase efficiency. By distributing the large output currents into several paralleled phases, currents in each phase are decreased. Thus, conduction losses associated with the square of the currents are decreased. For printed circuit board layouts of such a multi-phase converter, power loops and drive loops are coupled to a higher degree, when compared to a single-phase case. Such coupling in multi-phase power converters can result in undesirable parasitic drive loop and power loop inductances. Parasitic inductances in drive loops can cause oscillations, which can damage or destroy transistors.

Several different designs have been employed to optimize printed circuit board (PCB) layouts of multi-phase power converters. In one such design, transistors, drivers, and decoupling capacitors are placed in a line separately. Then, the drivers are placed between the transistors and capacitors. Inner layers are used for power loops. Spaces are needed between the drivers and decoupling capacitors for routing drive signals. The drive loop inductances are minimized but the power loop inductances are compromised.

In another design, through-hole transistors in different phases are placed in different lines. Decoupling capacitors are placed next to the transistors in each phase to minimize power loop inductances. Drivers are placed on the bottom side next to transistors to minimize drive loop inductances. This layout is not suitable for surface-mounted transistors.

In another design, drivers and transistors are integrated into single packages, which are placed next to decoupling capacitors. The drive loop inductances are minimized because of the integration. At the same time, the power loops are not compromised. However, this layout is not suitable for general cases where drivers and transistors are provided in different packages.

### SUMMARY

The present disclosure provides a multi-phase power converter. The multi-phase power converter includes a printed circuit board having a plurality of conductive layers in a spaced apart and parallel relationship, wherein the plurality of conductive layers includes a plurality of power planes in an interleaved configuration with alternating positive and negative voltages and configured to conduct a relatively high current for supplying to a load. The multi-phase power converter also includes a plurality of switching transistors disposed on an upper surface of the printed circuit board and configured to selectively conduct the relatively high current for supplying to the load. The plurality of conductive layers includes at least one signal plane disposed between the plurality of power planes and a surface of the printed circuit board, the at least one signal plane transmitting signals for controlling operation of the plurality of switching transistors

The present disclosure also provides a multi-phase power converter. The multi-phase power converter includes a printed circuit board and a power converter phase. The power converter phase includes a first bridge leg including a first high-side transistor and a first low-side transistor. The first high-side transistor is configured to selectively conduit current between a positive terminal of an input bus and a first intermediate node, and the first low-side transistor is configured to selectively conduit current between the first intermediate node and a negative terminal of the input bus. The power converter phase also includes a first driver circuit disposed adjacent to the first bridge leg. The first driver circuit is configured to generate drive signals for controlling operation of each of the first high-side transistor and the first low-side transistor. The power converter phase also includes a plurality of other power components disposed adjacent to the first bridge leg and opposite from the first driver circuit. The plurality of other power components is connected to the first intermediate node for receiving power therefrom.

The present disclosure also provides a method of operating a multi-phase power converter. The method includes: conducting, by a plurality of power planes of a plurality of conductive layers in a printed circuit board, a current for supplying to a load, wherein the plurality of conductive layers are arranged in a spaced apart and parallel relationship, and the plurality of power planes are arranged in an interleaved configuration with alternating positive and negative voltages; selectively conducting, by a plurality of switching transistors disposed on an upper surface of the printed circuit board, the current for supplying to the load; and transmitting, by at least one signal plane of the plurality of conductive layers, signals for controlling operation of the plurality of switching transistors, wherein the at least one signal plane is disposed between the plurality of power planes and a surface of the printed circuit board.

### BRIEF DESCRIPTION OF THE DRAWINGS

Further details, features and advantages of designs of the invention result from the following description of embodiment examples in reference to the associated drawings.

FIG. 1 shows a schematic diagram of a multi-phase power converter;

FIG. 2 shows a schematic diagram of a switch driver circuit of the multi-phase power converter of FIG. 1;

FIG. 3 shows a schematic diagram of a two-phase LLC power converter;

FIG. 4 shows a top view of a printed circuit board (PCB) layout for a multi-phase power converter in accordance with the present disclosure;

FIG. 5 shows a cutaway side view illustrating layers in a PCB in accordance with some embodiments of the present disclosure; and

FIG. 6 shows a power loop of a multi-phase converter using a PCB layout in accordance with the present disclosure;

FIG. 7 shows a generalized power loop of a multi-phase converter using a PCB layout in accordance with the present disclosure; and

FIG. 8 shows a flow chart illustrating steps in a method of operating a multi-phase power converter.

### DETAILED DESCRIPTION

Referring to the drawings, the present invention will be described in detail in view of following embodiments.

The present disclosure provides a novel printed circuit board (PCB) layout scheme for multi-phase power converters to simultaneously minimize drive and power loop inductances. The scheme minimizes the drive loop inductances by placing drivers next to the transistors. The power loop inductances could increase transistors' voltage stress and may also destroy transistors. The scheme minimizes the power loop inductances by minimizing the power loop area as much as possible and offering as many paths as possible for high-frequency currents. The PCB layout design of the present disclosure is applicable to both surface-mounted transistors and through-hole transistors in half-bridge and full-bridge configurations.

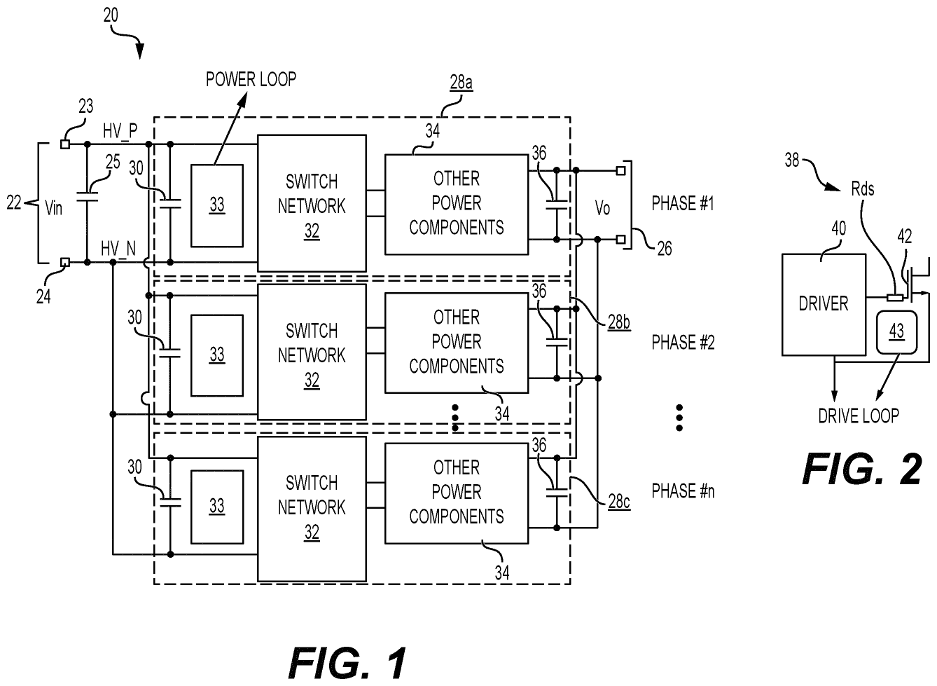

FIGS. 1-2 show power loops and drives loops in a typical multi-phase converter composed of switch networks and other power components, e.g., inductors, capacitors, and transformers.

FIG. 1 shows a schematic diagram of a multi-phase power converter 20. The multi-phase power converter 20 of FIG. 1 is configured to receive DC power from an input bus 22 having a positive terminal 23 defining a positive bus voltage HV_P, and a negative terminal 24 defining a negative bus voltage HV_N. An input capacitor 25 is connected across the positive terminal 23 and the negative terminal 24 of the input bus 22. The multi-phase power converter 20 supplies power to an output bus 26 at an output voltage Vo that may be different from an input voltage Vin on the input bus 22. The multi-phase power converter 20 includes a plurality of power converter phases 28a, 28b, 28c. In the example configuration shown in FIG. 1, three of the power converter phases 28a, 28b, 28c are shown. However, the multi-phase power converter 20 may have any number n of phases, where n is greater than 1.

Each of the power converter phases 28a, 28b, 28c of the multi-phase power converter 20 may have a similar or identical construction. For simplicity of the disclosure, a first power converter phase 28a is described in detail. The first power converter phase 28a includes an input capacitor 30 connected across the input bus 22. The first power converter phase 28a also includes a switch network 32 connected to the input bus 22. The switch network 32 may also be called an inverter stage and may include one or more switches, such as switching transistors that function to switch an input power at an operating frequency to generate a switched power that approximates an alternating current (AC) waveform. The switch network 32 could be implemented in a half-bridge configuration or a full-bridge configuration. In the course of operation, a power loop 33 may be generated in conductors between the input capacitor 30 and the switch network 32.

The first power converter phase 28a also includes other power components 34 that are supplied with power by the switch network 32. The other power components 34 may include one or more transformers, one or more inductors and/or capacitors, and/or one or more switches or diodes forming a rectifier. The other power components 34 may supply DC output power to the output bus 26. The first power converter phase 28a also includes an output capacitor 36 connected across the output bus 26 for smoothing ripples in the output voltage Vo that may be generated by operation of the switch network 32 and/or the other power components 34.

FIG. 2 shows a schematic diagram of a switch driver circuit 38 of the multi-phase power converter 20 of FIG. 1. The switch driver circuit 38 includes a driver 40 coupled to a switching transistor 42, such as a field-effect transistor 42. The driver 40 produces a control signal that is applied to the gate of the switching transistor 42 for controlling the operation of the switching transistor 42. The switch driver circuit 38 defines a drive loop 43, which is a current loop of the control signal that is applied to the gate of the switching transistor 42. An input resistance Rds, which may include a drain-source resistance of the switching transistor 42, is also shown in the drive loop 43. This input resistance Rds may be a characteristic of the switching transistor 42 and not a separate physical device.

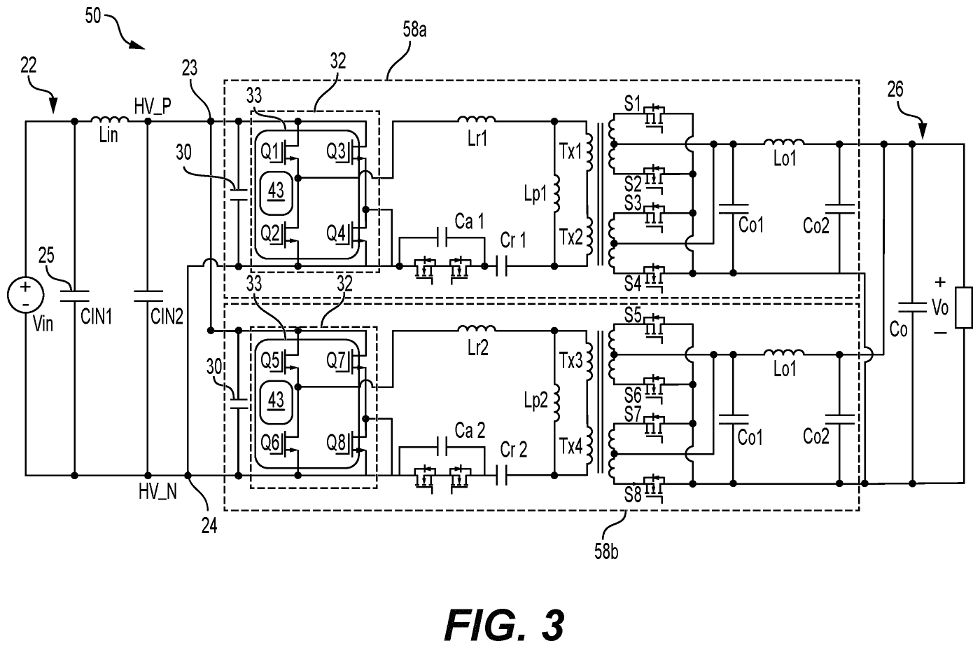

FIG. 3 shows a two-phase inductor-inductor-capacitor (LLC) power converter 50, including a first LLC power converter phase 58a and a second LLC power converter phase 58b. This is merely an example, and the principles of the present disclosure may be applied to several different types of power converters having a different number of phases, such as two phases, three phases, four phases, etc.

The LLC power converter 50 may show a particular implementation of the more general multi-phase power converter 20 of FIG. 1. FIG. 3 shows the LLC power converter 50 including the first LLC power converter phase 58a and the second LLC power converter converter phase 58b. Each of the LLC converter phases have a switch network 32 with a full-bridge configuration and providing a corresponding power loop 33. One drive loop 43 is also shown in each of the switch networks 32 of FIG. 3. However, the LLC power converter 50 may include drive loop 43 for each of the switching transistors included therein.

Parasitic inductances in the drive loops 43 can cause the gate voltage of transistors to oscillate. The oscillations at turning on moments can destroy the gate of the transistors. While the oscillations at turning off moments can cause transistors to inadvertently turn on, which can cause a short circuit through two transistors of a bridge leg, which can destroy the two transistors. The parasitic inductances in the power loop 33 may induce oscillations in the drain-to-source voltages of the transistors, increasing their voltage stress, which is associated with the on-state resistance Rds (on) and the price. In addition, the oscillations can increase electromagnetic emission and radiation level of the devices, which may be harmful to other devices. Thus, minimizing the drive and power loop inductances are two major objectives in a PCB layout.

The proposed multi-phase converter PCB layout scheme minimizes the drive and power loop inductances simultaneously and is suitable for surface-mounted and through-hole transistors in half-bridge or full-bridge configurations. The proposed PCB layout scheme provides for reduced drive loop inductances by placing drivers next to the transistors. The proposed PCB layout scheme also provides for reduced power loop inductances when compared with conventional designs by minimizing the power loop area and providing many different paths for high-frequency currents.

### Structure and Design of the Multi-Phase Converter PCB Layout

The PCB layout of the present disclosure is configured to simultaneously minimize drive loop and power loop inductances. The following details an example of the structure and design of the proposed multi-phase converter PCB layout. Although the example uses a full-bridge structure for the switch network, with two-channel drivers for high side and low side transistors, and using surface mounted technology (SMT) package for the transistors, it should be noted that the proposed layout can also be applied to a switch network 32 with a half-bridge configuration, single-channel drivers for high side and low side components, and transistors with through-hole technology (THT).

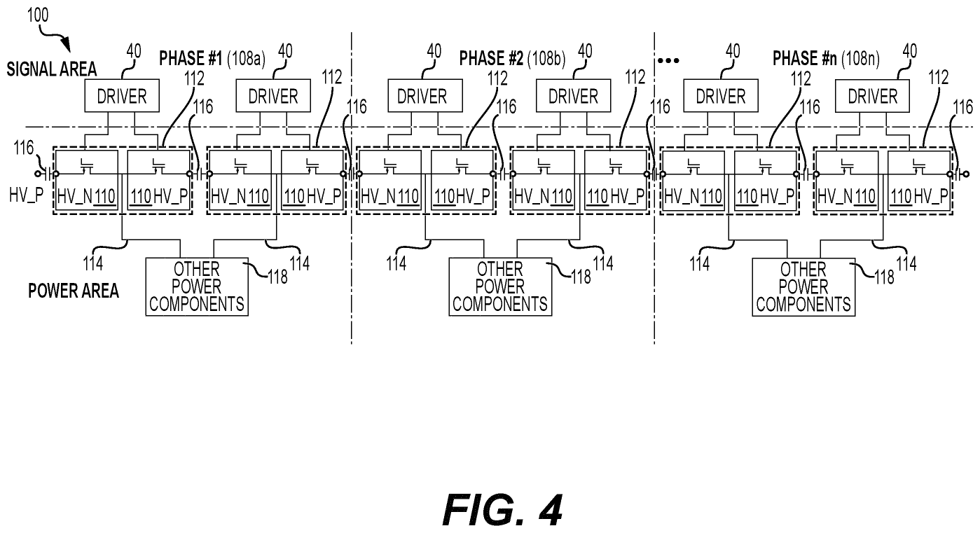

FIG. 4 shows a top view of a PCB layout 100 for a multi-phase converter, in accordance with an aspect of the present disclosure. The PCB layout 100 includes a plurality of switching transistors 110, such as FETs arranged in a line. The plurality of switching transistors 110 are arranged in bridge legs 112. Each bridge leg 112 includes a high-side transistor and a low-side transistor. The high-side transistor is configured to selectively conduit current between a positive terminal HV_P of an input bus and an intermediate node 114. The low-side transistor is configured to selectively conduit current between the intermediate node 114 and a negative terminal HV_N of the input bus. The switching transistors 110 in the switch networks are placed in a line with high side and low side transistors interleaved. High side transistors are those connected with the positive bus voltage (HV_P), while low side transistors are those connected with the negative bus voltage (HV_N). Local decoupling capacitors 116 are located between each bridge leg composed of a high side and a low side transistor to supply high-frequency currents, no matter if the bridge leg is in the same phases or different phases. The local decoupling capacitors 116 may be used instead of or in addition to the input capacitors 30 connected across the positive terminal HV_P and the negative terminal HV_N of the input bus 22. Thanks to these local decoupling capacitors 116, bulk capacitors supplying low-frequency currents can be placed far away from the switching transistors 110. The copper areas with HV_P or HV_N nets are connected to inner HV_P and HV_N layers with vias. Drivers 40 are placed above and next to the bridge legs 112, as close as possible, so that inductances of the drive loops 43 are minimized. Other components 118, such as inductors, capacitors, etc. are placed under the bridge legs 112. By doing so, the signal area and power area are decoupled, which significantly decreases the difficulties of routing even if the power area has high voltages.

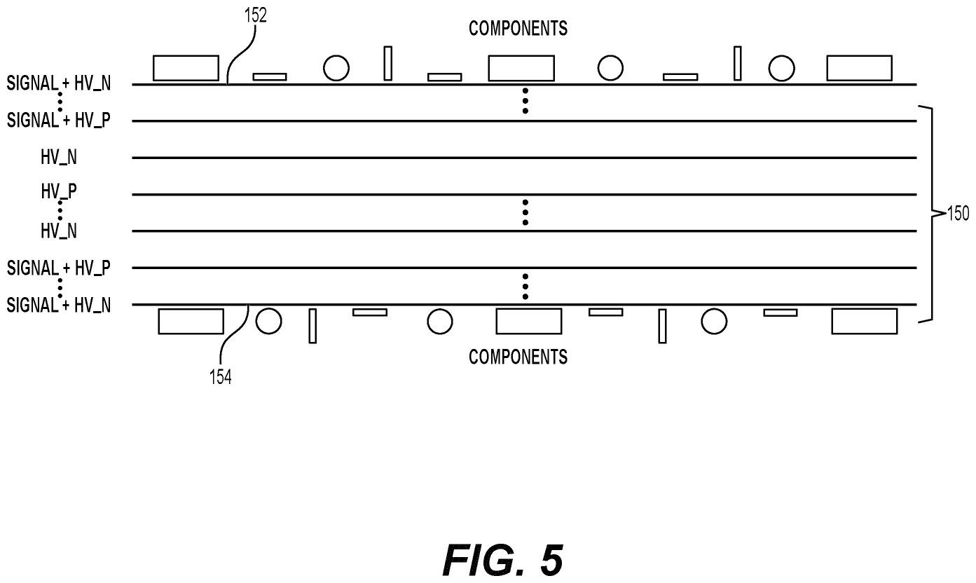

FIG. 5 shows a cutaway side view illustrating the PCB stack-up of the proposed PCB layout. A multi-layer PCB 150 is used for the proposal.

The multi-layer PCB 150 includes an upper surface 152 and a lower surface 154 opposite the upper surface 152. Components are placed on the upper surface 152 and/or lower surface 154. Outer layers adjacent to the upper surface 152 and/or lower surface 154 may be used for signals such as driving, protection, and control signals and HV_P or HV_N bus voltages. In outer layers, the signal area in the top view is for signals, while the power area is for HV_P or HV_N bus voltages. The number of signal layers can be determined according to the complexity of the signals and cost limitations. Signal grounds can also be acquired in the signal area of these layers to improve the signal quality. Local driving grounds can be used underneath the drivers to further minimize the drive loop inductances. The inner layers are for HV_P and HV_N bus voltages. The number of the HV_P and HV_N voltages are selected according to the current rating and the cost limitation. All the whole layers are for HV_P or HV_N bus voltages. The HV_P layers and HV_N layers are interleaved as much as possible so that the parasitic capacitances between HV_P and HV_N are maximized. These parasitic capacitances offer additional paths for very high-frequency currents of the power loop (and may supplement the local decoupling capacitors 116), such that the power loop inductances are further minimized except for the mechanism explained in the following.

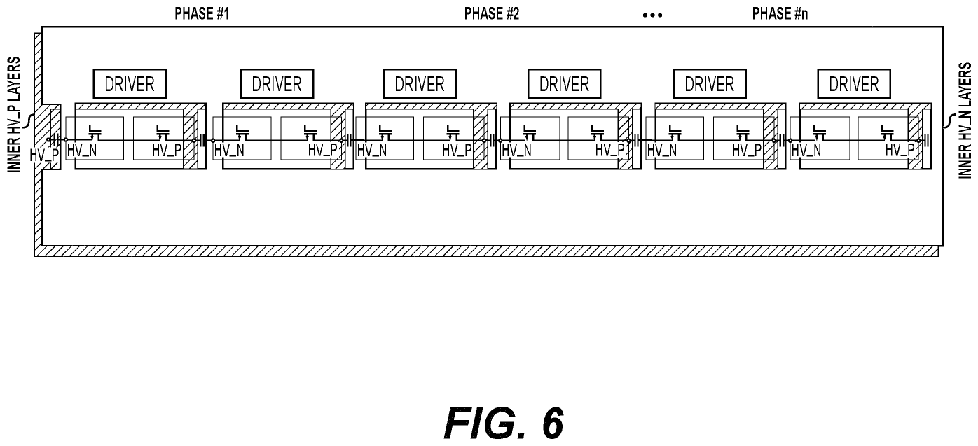

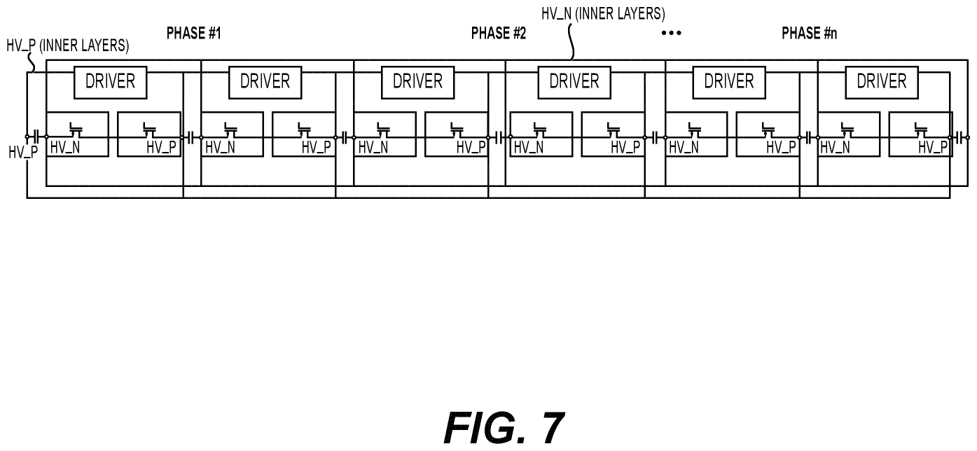

FIG. 6 shows the power loop of the proposed multi-phase converter PCB layout. FIG. 7 shows the associated abstract power loop. It should be noted that the figures are associated with SMT transistors with bottom side cooling and through-hole transistors. The copper underneath the transistors may not be available for use to distribute the HV_P and HV_N bus voltages because of thermal vias mounted underneath the transistors for bottom cooling or the through-hole pads. For this configuration, the power loops composed of bridge legs and local decoupling capacitors 116 are closed by the lateral HV_P or HV_N copper areas. The local decoupling capacitors 116 can offer high-frequency currents not only for the bridge legs next to the capacitors but also for those far away from the capacitors. By doing so, the power loop area is minimized. In addition, as many paths as possible are offered for the high-frequency currents. Thus, the power loop inductances are minimized. For SMT transistors with top side cooling, the copper area underneath the transistors can be used for HV_P and HV_N voltages. The power loop inductances can be further minimized.

In summary, by placing drivers next to the transistors, the drive loop inductances are minimized. By minimizing the power loop area, and providing many different paths for the high-frequency currents, the power loop inductances are minimized. In the proposal, the drive and power loop inductances are minimized simultaneously.

The present disclosure provides a multi-phase power converter. The multi-phase power converter includes a printed circuit board having a plurality of conductive layers in a spaced apart and parallel relationship, wherein the plurality of conductive layers includes a plurality of power planes in an interleaved configuration with alternating positive and negative voltages and configured to conduct a relatively high current for supplying to a load. The multi-phase power converter also includes a plurality of switching transistors disposed on an upper surface of the printed circuit board and configured to selectively conduct the relatively high current for supplying to the load. The plurality of conductive layers includes at least one signal plane disposed between the plurality of power planes and a surface of the printed circuit board, the at least one signal plane transmitting signals for controlling operation of the plurality of switching transistors.

In some embodiments, the multi-phase power converter further includes a plurality of power components disposed on the upper surface of the printed circuit board and on a lower surface opposite of the upper surface of the printed circuit board.

In some embodiments, the at least one signal plane includes a power area configured to conduct substantially higher current than the signals for controlling operation of the plurality of switching transistors.

In some embodiments, the at least one signal plane includes two or more signal planes disposed adjacent to one another.

In some embodiments, the multi-phase power converter further includes a second signal plane disposed between the plurality of power planes and a lower surface of the printed circuit board opposite of the upper surface of the printed circuit board.

The present disclosure provides a multi-phase power converter comprising a printed circuit board and a power converter phase. The power converter phase includes a first bridge leg. The first bridge leg includes a first high-side transistor and a first low-side transistor. The first high-side transistor is configured to selectively conduit current between a positive terminal of an input bus and a first intermediate node, and the first low-side transistor is configured to selectively conduit current between the first intermediate node and a negative terminal of the input bus. The power converter phase also includes a first driver circuit disposed adjacent to the first bridge leg and configured to generate drive signals for controlling operation of each of the first high-side transistor and the first lowside transistor. The power converter phase also includes a plurality of other power components disposed adjacent to the first bridge leg and opposite from the first driver circuit, the plurality of other power components connected to the first intermediate node for receiving power therefrom. The multi-phase power converter may be shown in FIG. 4 and described herein.

In some embodiments, the power converter phase further includes a second bridge leg including a second high-side transistor and a second low-side transistor, the second high-side transistor configured to selectively conduit current between the positive terminal of the input bus and a second intermediate node, and the second low-side transistor configured to selectively conduit current between the second intermediate node and the negative terminal of the input bus. The power converter phase may also include a second driver circuit disposed adjacent to the second bridge leg and configured to generate drive signals for controlling the operation of each of the second high-side transistor and the second low side transistor. The plurality of other power components may be disposed adjacent to the second bridge leg and opposite from the second driver circuit, the plurality of other power components connected to the second intermediate node for receiving power therefrom.

In some embodiments, the power converter phase is one of a plurality of power converter phases each disposed on the printed circuit board.

In some embodiments, the plurality of power converter phases each include corresponding switching transistors arranged in a straight line.

In some embodiments, the plurality of power converter phases each include corresponding driver circuits arranged on a same side of the straight line of the switching transistors.

In some embodiments, the first bridge leg is one of a plurality of sets of switching transistors each defining a corresponding bridge leg, and the multi-phase power converter includes a local decoupling capacitor located between each set of set of switching transistors and configured to supply high-frequency currents thereto.

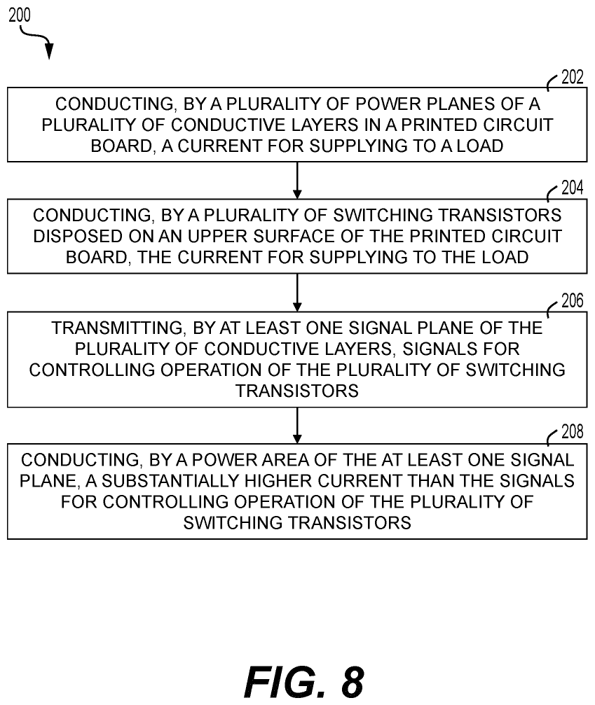

A method 200 of operating a multi-phase power converter is shown in the flow chart of FIG. 8. As can be appreciated in light of the disclosure, the order of operation within the method is not limited to the sequential execution as illustrated in FIG. 8, but may be performed in one or more varying orders as applicable and in accordance with the present disclosure.

The method 200 includes conducting, by a plurality of power planes of a plurality of conductive layers in a printed circuit board, a current for supplying to a load at step 202, where the plurality of conductive layers are arranged in a spaced apart and parallel relationship, and the plurality of power planes are arranged in an interleaved configuration with alternating positive and negative voltages.

The method 200 also includes selectively conducting, by a plurality of switching transistors disposed on an upper surface of the printed circuit board, the current for supplying to the load at step 204.

The method 200 also includes transmitting, by at least one signal plane of the plurality of conductive layers, signals for controlling operation of the plurality of switching transistors at step 206, where the at least one signal plane is disposed between the plurality of power planes and a surface of the printed circuit board.

The method 200 also includes conducting, by a power area of the at least one signal plane, a substantially higher current than the signals for controlling operation of the plurality of switching transistors, at step 208.

In some embodiments, the at least one signal plane includes two or more signal planes disposed adjacent to one another.

In some embodiments, the printed circuit board further includes a second signal plane disposed between the plurality of power planes and a lower surface of the printed circuit board opposite of the upper surface of the printed circuit board.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

In the claims:

1. A multi-phase power converter comprising:
a printed circuit board having a plurality of conductive layers in a spaced apart and parallel relationship, wherein the plurality of conductive layers includes a plurality of power planes in an interleaved configuration with alternating positive and negative volt-ages and configured to conduct a relatively high current for supplying to a load; and
a plurality of switching transistors disposed on an upper surface of the printed circuit board and configured to selectively conduct the relatively high current for supplying to the load,
wherein the plurality of conductive layers includes at least one signal plane disposed between the plurality of power planes and a surface of the printed circuit board, the at least one signal plane transmitting signals for controlling operation of the plurality of switching transistors.

2. The multi-phase power converter of claim 1, further comprising a plurality of power components disposed on the upper surface of the printed circuit board and on a lower surface opposite of the upper surface of the printed circuit board.

3. The multi-phase power converter of claim 1, wherein the at least one signal plane includes a power area configured to conduct substantially higher current than the signals for controlling operation of the plurality of switching transistors.

4. The multi-phase power converter of claim 1, wherein the at least one signal plane includes two or more signal planes disposed adjacent to one another.

5. The multi-phase power converter of claim 1, further comprising a second signal plane disposed between the plurality of power planes and a lower surface of the printed circuit board opposite of the upper surface of the printed circuit board.

6. A multi-phase power converter comprising:
a printed circuit board; and
a power converter phase including:
a first bridge leg including a first high-side transistor and a first low-side transistor, the first high-side transistor configured to selectively conduit current between a positive terminal of an input bus and a first intermediate node, and the first low-side transistor configured to selectively conduit current between the first intermediate node and a negative terminal of the input bus;
a first driver circuit disposed adjacent to the first bridge leg and configured to generate drive signals for controlling operation of each of the first high-side transistor and the first low-side transistor; and
a plurality of other power components disposed adjacent to the first bridge leg and opposite from the first driver circuit, the plurality of other power components connected to the first intermediate node for receiving power therefrom.

7. The multi-phase power converter of claim 6, wherein the power converter phase further includes:
a second bridge leg including a second high-side transistor and a second low-side transistor, the second high-side transistor configured to selectively conduit current between the positive terminal of the input bus and a second intermediate node, and the second low-side transistor configured to selectively conduit current between the second intermediate node and the negative terminal of the input bus; and
a second driver circuit disposed adjacent to the second bridge leg and configured to generate drive signals for controlling the operation of each of the second high-side transistor and the second low-side transistor,
wherein the plurality of other power components is disposed adjacent to the second bridge leg and opposite from the second driver circuit, the plurality of other power components connected to the second intermediate node for receiving power therefrom.

8. The multi-phase power converter of claim 6, wherein the power converter phase is one of a plurality of power converter phases each disposed on the printed circuit board.

9. The multi-phase power converter of claim 8, wherein the plurality of power converter phases each include corresponding switching transistors arranged in a straight line.

10. The multi-phase power converter of claim 9, wherein the plurality of power converter phases each include corresponding driver circuits arranged on a same side of the straight line of the switching transistors.

11. The multi-phase power converter of claim 6, wherein the first bridge leg is one of a plurality of sets of switching transistors each defining a corresponding bridge leg; and
a local decoupling capacitor located between each set of set of switching transistors and configured to supply high-frequency currents thereto.

12. A method of operating a multi-phase power converter, comprising:
conducting, by a plurality of power planes of a plurality of conductive layers in a printed circuit board, a current for supplying to a load, wherein the plurality of conductive layers are arranged in a spaced apart and parallel relationship, and the plurality of power planes are arranged in an interleaved configuration with alternating positive and negative voltages;
selectively conducting, by a plurality of switching transistors disposed on an upper surface of the printed circuit board, the current for supplying to the load; and
transmitting, by at least one signal plane of the plurality of conductive layers, signals for controlling operation of the plurality of switching transistors, wherein the at least one signal plane is disposed between the plurality of power planes and a surface of the printed circuit board.

13. The method of claim 12, further comprising conducting, by a power area of the at least one signal plane, a substantially higher current than the signals for controlling operation of the plurality of switching transistors.

14. The method of claim 12, wherein the at least one signal plane includes two or more signal planes disposed adjacent to one another.

15. The method of claim 12, wherein the printed circuit board further includes a second signal plane disposed between the plurality of power planes and a lower surface of the printed circuit board opposite of the upper surface of the printed circuit board.

16. The multi-phase power converter of claim 1, further including a power converter phase, wherein the power converter phase includes:
a first bridge leg including a first high-side transistor and a first low-side transistor, the first high-side transistor configured to selectively conduit current between a positive terminal of an input bus and a first intermediate node, and the first low-side transistor configured to selectively conduit current between the first intermediate node and a negative terminal of the input bus;
a first driver circuit disposed adjacent to the first bridge leg and configured to generate drive signals for controlling operation of each of the first high-side transistor and the first low-side transistor; and
a plurality of other power components disposed adjacent to the first bridge leg and opposite from the first driver circuit, the plurality of other power components connected to the first intermediate node for receiving power therefrom.

17. The multi-phase power converter of claim 16, wherein the power converter phase further includes:
a second bridge leg including a second high-side transistor and a second low-side transistor, the second high-side transistor configured to selectively conduit current between the positive terminal of the input bus and a second intermediate node, and the second low-side transistor configured to selectively conduit current between the second intermediate node and the negative terminal of the input bus; and
a second driver circuit disposed adjacent to the second bridge leg and configured to generate drive signals for controlling the operation of each of the second high-side transistor and the second low-side transistor,
wherein the plurality of other power components is disposed adjacent to the second bridge leg and opposite from the second driver circuit, the plurality of other power components connected to the second intermediate node for receiving power therefrom.

18. The multi-phase power converter of claim 16, wherein the power converter phase is one of a plurality of power converter phases each disposed on the printed circuit board, and
wherein the plurality of power converter phases each include corresponding switching transistors arranged in a straight line.

19. The multi-phase power converter of claim 18, wherein the plurality of power converter phases each include corresponding driver circuits arranged on a same side of the straight line of the switching transistors.

20. The multi-phase power converter of claim 16, wherein the first bridge leg is one of a plurality of sets of switching transistors each defining a corresponding bridge leg; and
a local decoupling capacitor located between each set of set of switching transistors and configured to supply high-frequency currents thereto.
